(19) United States
(12) Patent Application Publication
(10) Pub. No.: US 2026/0093521 A1
(43) Pub. Date: Apr. 2, 2026

(54) ELECTION OF A CONTAINER FOR DELEGATION OF TASKS IN A DEPLOYMENT

(71) Applicant: Dell Products L.P., Round Rock, TX (US)

(72) Inventors: ROMAN BOBER, Ashdod (IL); MAXIM BALIN, Gan-Yavne (IL); SHIRA RIVKA REDLICH, Jerusalem (IL)

(21) Appl. No.: 18/899,272

(22) Filed: Sep. 27, 2024

(51) Int. Cl. G06F 9/48

(52) U.S. Cl. CPC G06F 9/4881

(57) ABSTRACT

Methods and systems for managing operation of a deployment are disclosed. The operation may be managed by distributing resources of a pod towards performance of a task. The resources may be distributed by assigning a container of the pod to be a leader container. The leader container may be selected from a set of containers in the deployment that meet security requirements. The leader container may delegate, based on a policy of a second container, the task to the second container. The second container may perform the task to provide a computer implemented service.

### FIELD

Embodiments disclosed herein relate generally to managing operation of a deployment. More particularly, embodiments disclosed herein relate to selecting a container to delegate tasks to containers in a deployment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show interaction diagrams illustrating operation of a system in accordance with an embodiment.

FIGS. 3A-3C show flow diagrams illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a deployment. The deployment may be managed by distributing resources of a pod when a load of the deployment is scaled. To distribute the resources of the pod, a container from the pod may be chosen to be a leader container. To choose the leader container, a remote management entity may select a container that has (i) enhanced security protocols, (ii) increased available resources to manage tasks, (iii) continuous scanning for malicious activity, etc.

To manage a load of the deployment that is scaled, the leader container may delegate tasks to a remaining set of containers of the pod. The remaining set of the containers may include follower containers. A follower container of the follower containers may receive, based on a policy of the follower container and from the leader container, a task to perform to provide at least one computer implemented service.

If the leader container shuts off and/or an edge device, which includes the leader container, powers down, the remote management entity may choose a new leader container from containers in the deployment. After a new leader container is selected and the tasks are delegated to the follower containers, the load of the deployment may continue to be managed.

In an embodiment, a method for managing operation of a deployment is disclosed. The method may include (i) obtaining, by a first container of a pod hosted by the deployment, a task from a task manager to provide at least one computer implemented service, (ii) obtaining, based on the task, by the first container and from a second container of the pod, at least a policy and an available workload capacity for taking on additional tasks by the second container that are usable to identify whether the task can be performed by the second container, (iii) making, based on at least the policy and the available workload capacity, a determination regarding whether the task can be performed by the second container, (iv) in a first instance of the determination where the task can be performed by the second container: (a) assigning, to the second container, the task to be performed and (b) monitoring, by the first container, performance of the task by the second container to ensure that the at least one computer implemented service is being provided by the performance of the task.

The method may further include, before obtaining the task from the task manager: (i) receiving, from a remote management entity, a first notice that an election is taking place to choose a leader container from a set of containers, (ii) sending, to the remote management entity, a signature to be selected as the leader container, (iii) receiving a second notice that the signature was selected by the remote management entity to be designated as the leader container and (iv) receiving, from a follower container, a third notice that the follower container is ready to receive the task.

The signature may be used to identify the pod among the set of the containers.

The method may include, after obtaining the task from the task manager: (i) receiving, from a remote management entity, a third notice that a signature for the container has been removed, thereby removing the container from a leadership position, (ii) receiving, from the remote management entity, a fourth notice that a second election is taking place to choose a leader container from a set of the containers, (iii) receiving a fifth notice that the signature was selected by the remote management entity to be designated as a new leader container and (iv) sending, to the new leader container, a sixth notice that the task is ready to be received. The task manager may aggregate tasks in a list of the tasks and does not balance the available workload capacity for containers.

The first container may acquire the task from the list of the tasks aggregated by the task manager to send to the second container.

The first container may be a leader that delegates the task to the second container, the second container being a follower that accomplishes the task, and the leader is selected in an election, by an elector, between the first container and the second container that chooses which container can more efficiently delegate the task, monitor performance of the task, and is more secure.

The policy may include a decision-making procedure that regulates, based on at least a first type of operation, an allowable allocation of resources, and a second type of data that is ingested in the operation, whether a task can be completed by a container.

Making the determination regarding whether the task can be performed may include (i) screening, by the first container, the policy of the second container to ingest parameters of the decision-making procedure that regulates whether the task can be completed by the second container, (ii) determining, by the first container and based on the parameters of the decision-making procedure, whether performance of the task by the second container is prohibited by the policy of the second container and (iii) determining, by the first container, whether performance of the task can be done within the available workload capacity.

Performance of the task by the second container may depend on whether the performance can be completed within a timeframe based on a service limit understood by the first container.

The determination may be made based on computational efficiency criteria that comprises at least a high proximity to data sources.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

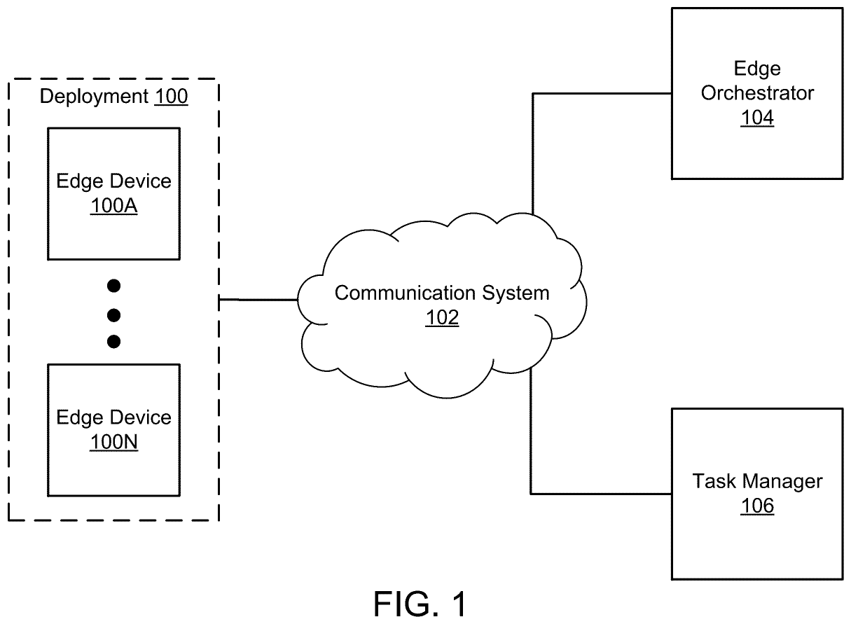

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a pod may be deployed to run applications on edge devices and manage the edge devices. The pod may include a collection of containers and a container of the containers may include at least one application and dependencies of the at least one application. The edge devices may be any number of devices (cameras, sensors, etc.) that generates data from observing an external environment (at least one field in a farm, at least one block in a city, etc.). The data may be processed by at least one container in the pod using the applications.

As a size of the external environment increases, more of the edge devices may be deployed. With an increase in a number of the edge devices, a volume of the data may increase. With the higher volume of the data, the pod may inefficiently distribute resources of the containers of the pod from the higher volume of the data among the at least one container. The inefficiency may include memory overloading, read/write bottlenecks, increased latency, etc. As a result of the inefficiency, provisioning of the computer implemented services may be adversely impacted.

In general, embodiments disclosed here relate to systems and methods for managing operation of a deployment. The operation may be managed by allocating resources of the containers of the pod. The resources may include a task that may be performed by a container of the containers. The resources may be allocated by selecting a leader container of the pod. The leader container may allocate a task to a follower container. The follower container may receive the task. Upon receiving the task, the follower container may access data from a data source. The data may be ingested by an application that is managed by the follower container and the application may be run.

Before the follower container is chosen, the leader container may be chosen. The leader container may be chosen by facilitating an election, by an edge orchestrator, for a leader container from the containers of a pod. During the election, the edge orchestrator may send a notice to the containers that a leader container is needed to distribute resources in a deployment of edge devices. The notice may include requirements to qualify as the leader container. The requirements may include (i) enhanced security protocols, (ii) increased available resources to manage tasks, (iii) continuous scanning for malicious activity, etc. A portion of the containers that meet the requirements of the leader container may respond to the edge orchestrator. A container of the portion of the containers may respond by sending a signature of the container to the edge orchestrator. The signature may be used to identify the container.

The edge orchestrator may receive the signature of the container of the portion of the containers. The edge orchestrator may then select the container to be the leader container. The edge orchestrator may select the leader container by (i) using the signature of the container to perform a lookup of attributes of the container of the portion of the containers, and (ii) select the container, which has the attributes that meet the requirements, to be the leader container.

Upon selection of the leader container, a remaining set of containers may become follower containers. The edge orchestrator may then send a second notice to the follower containers that the leader container has been chosen. As a result of the second notice, the follower containers may monitor activity of the leader container. The follower containers may monitor activity by focusing on a performance of activities of the leader container. The follower containers may monitor activity because the leader container may delegate tasks to be run by the follower containers.

As the leader container delegates a task, a follower container may receive the task. As the follower container receives the task, the follower container may, based on the task, access data from a data source and run an application with the data. By running the application, by the follower container, resources of a pod may be efficiently distributed in a deployment and therefore computer implemented services may be provided.

To provide the above noted functionality, the system may include deployment 100, edge orchestrator 104, and task manager 106. Each of these components is discussed below.

Deployment 100 may include edge device 100A-100N. Any number of edge device 100A-100N may perform computer implemented services by collecting data from a data source and transferring the data to at least one application. The at least one application may be run by a container from a pod.

The any number of edge device 100A-100N may include any number of devices (cameras, sensors, etc.) that captures information about an environment (at least one field in a farm, at least one block in a city, etc.) and stores the information as data. The application may ingest the data to perform the computer implemented service. Examples of the computer implemented services may include (i) identifying citizens in the city by ingesting the data about physical characteristics, (ii) identifying crops in at least one field in the farm, etc.

The any number of edge device 100A-100N may be tasked to provide the computer implemented services. The any number of edge device 100A-100N may be tasked by receiving a task to perform from a container from an edge device of the any number of edge device 100A-100N. The container may send a task to a second container in the any number of edge device 100A-100N. The container that sends the task may be a leader container and the second container that performs the task may be a follower container.

To select which container in deployment 100 becomes the leader container, edge orchestrator 104 may perform an election. Edge orchestrator 104 may perform the election by notifying the containers that an election is being conducted, by edge orchestrator 104, to select the leader container. The notice may include requirements to qualify as the leader container. The requirements may include (i) enhanced security protocols, (ii) increased available resources to manage tasks, (iii) continuous scanning for malicious activity, etc.

In response to the notice, edge orchestrator 104 may receive, from a container, a signature of the container. The signature may be used by edge orchestrator 104 to identify the container. From each signature, edge orchestrator 104 may select the leader container by (i) using the signature of the container to perform a lookup of attributes of the container, and (ii) select the container, which has the attributes that meet the requirements, to be the leader container.

Once the leader container has been selected, the leader container may receive a task from task manager 106. Task manager 106 may catalogue a task that can be done by a container. Task manager 106 may send the task to the leader container for provision of the computer implemented service. The leader container may facilitate the provision of the computer implemented service by assigning the task to a follower container. The follower container may provide the computer implemented service by performing the task.

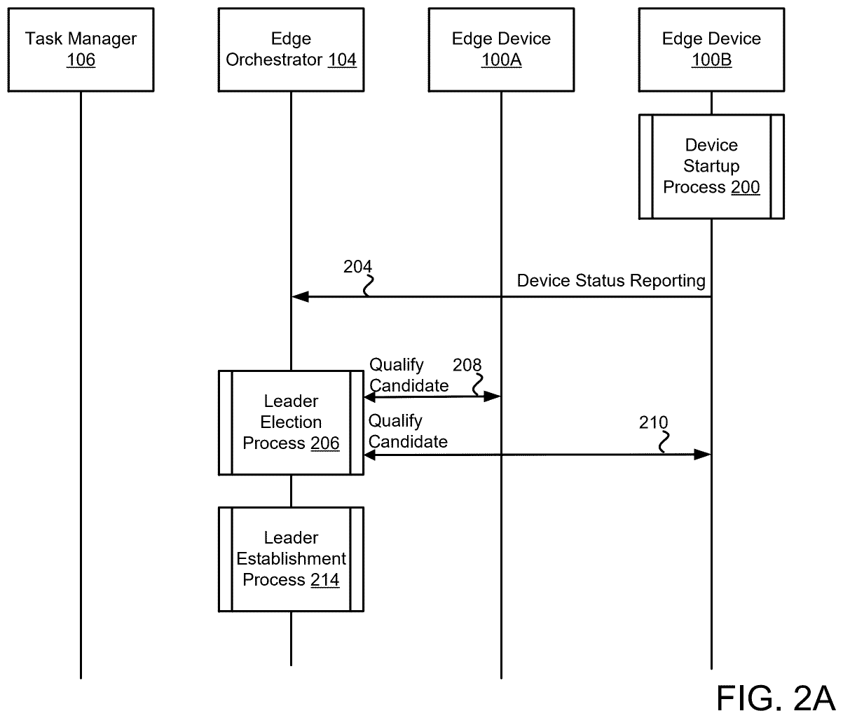

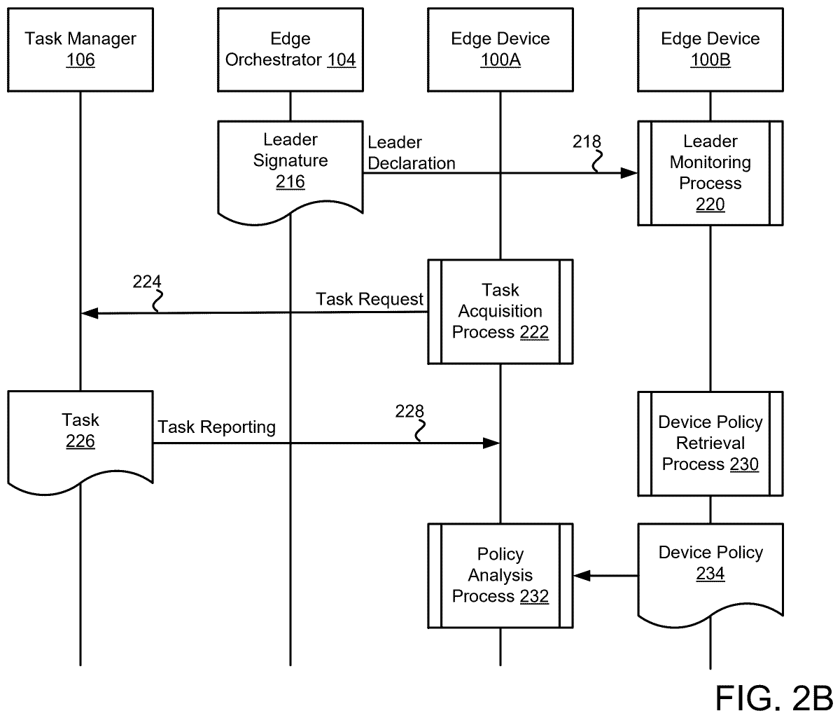

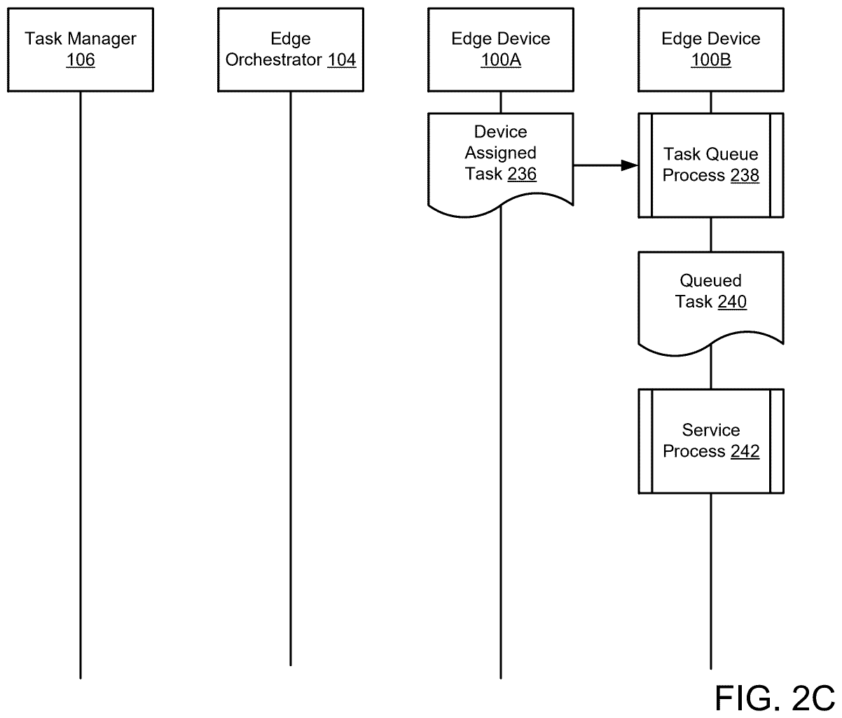

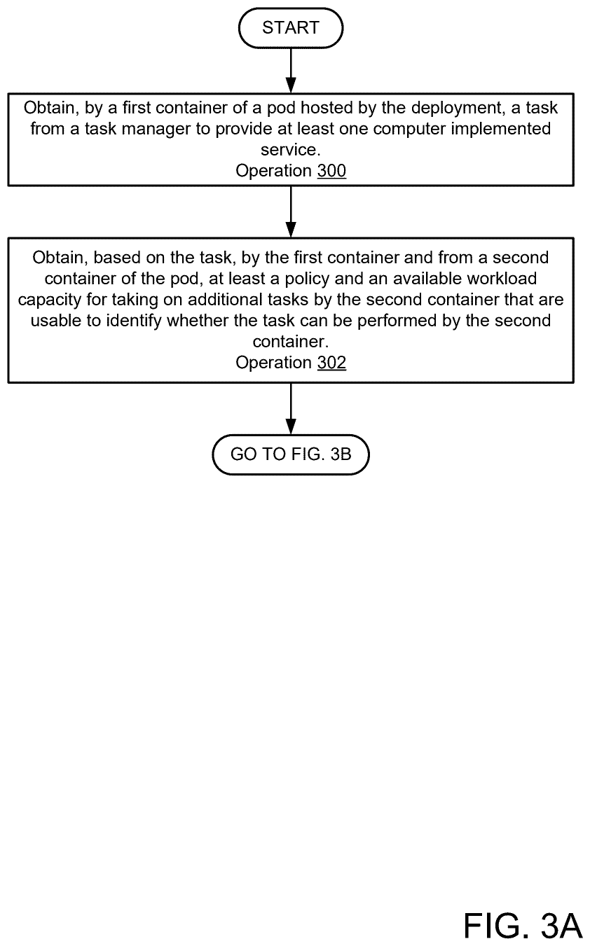

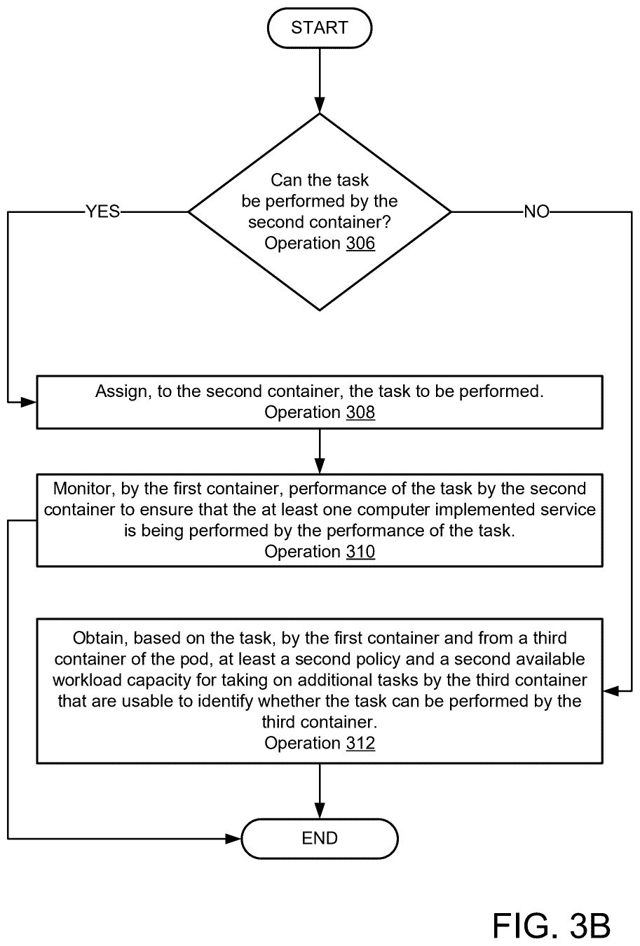

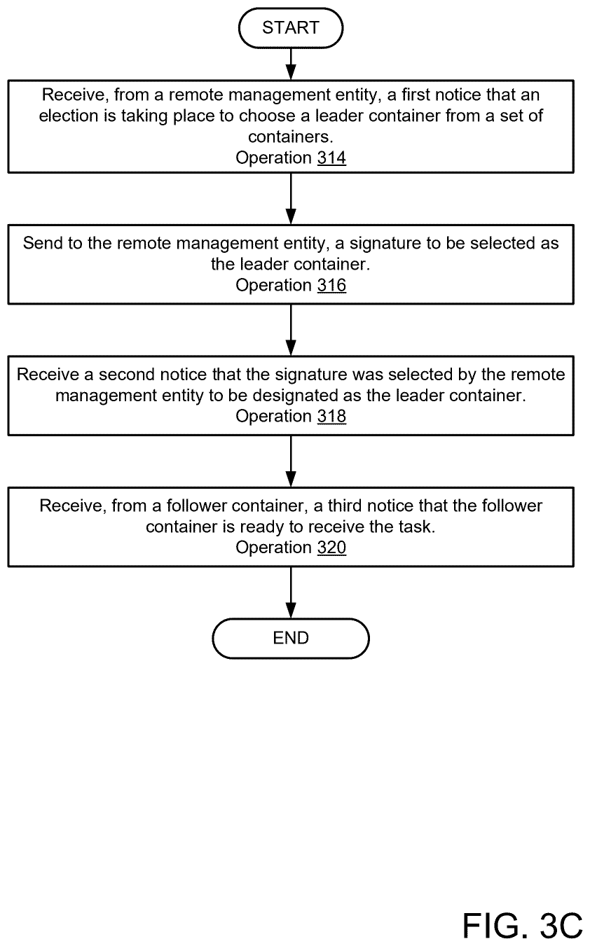

While providing their functionality, any of deployment 100, edge orchestrator 104, and task manager 106 may perform all, or a portion, of the flows and methods shown in FIGS. 2A-3C.

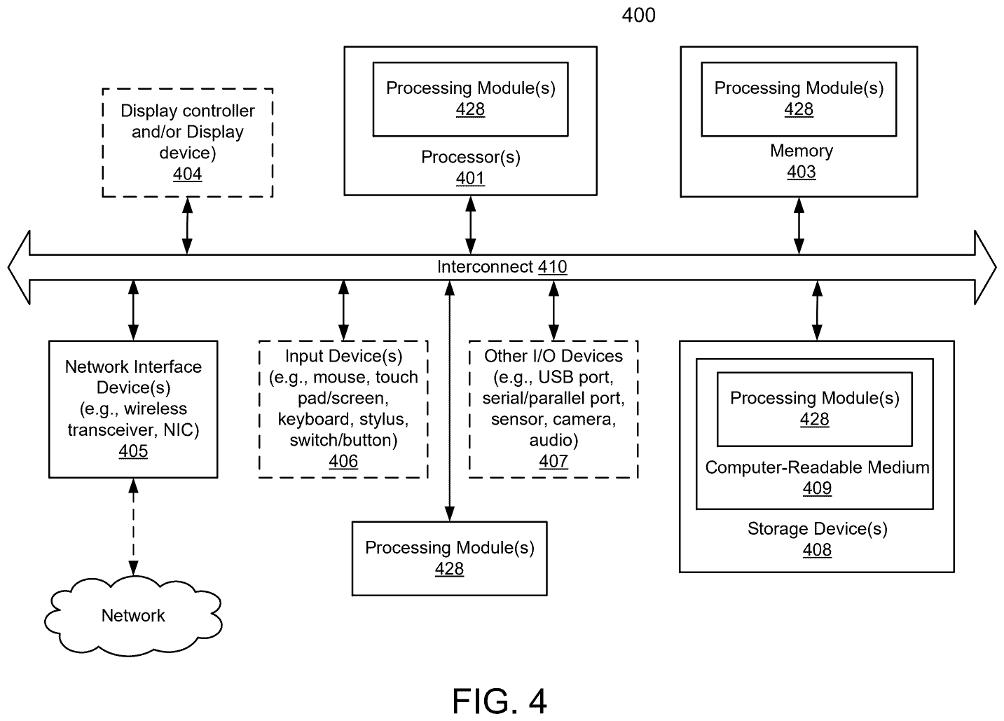

Any of (and/or components thereof) deployment 100, edge orchestrator 104, and task manager 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, interactions diagrams in accordance with an embodiment are shown in FIGS. 2A-2C. These interactions diagrams may illustrate how data may be obtained and used within the system of FIG. 2A-2C.

In the interaction diagrams, processes performed by and interactions between components of a system in accordance with an embodiment are shown. In the diagrams, components of the system are illustrated using a first set of shapes (e.g., 100A, 106, etc.), located towards the top of each figure. Lines descend from these shapes. Processes performed by the components of the system are illustrated using a second set of shapes (e.g., 200, 206, etc.) superimposed over these lines. Interactions (e.g., communication, data transmissions, etc.) between the components of the system are illustrated using a third set of shapes (e.g., 204, 208, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 204 may occur prior to the interaction labeled as 208. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate data used in and data processing performed in selecting a leader container.

To select the leader container, device startup process 200 may be performed. During device startup process 200, a series of activities may be performed. The activities include (i) powering on using an electrical signal, (ii) performing a self-test to ensure a computing processing unit, memory, storage device, etc. are functioning correctly, (iii) starting a bootloader which is used to load an operating system into memory, (iv) loading a kernel, which manages hardware and software in edge device 100B, (v) starting system services and background processes to make edge device 100B function properly, (vi) initiating a leader/follower status resolution to determine if a device includes a container that has been established as a leader, a follower, and/or neither, etc.

After device startup process 200, a status of the device may be reported to edge orchestrator 104. For example, at interaction 204, an indication of a health state of edge device 100B may be passed to edge orchestrator 104. A normal health state may indicate that no errors occurred during a performance of sub-processes in device startup process 200. An indication that no errors occurred may be communicated using messages from the sub-processes, sounds made by edge device 100B, etc.

The health state of edge device 100B may be sent by transmitting the messages from the sub-processes to edge orchestrator 104. The messages may indicate a normal start-up and an active mode in which edge device 100B is ready to perform tasks to provide computer implemented services.

Once edge orchestrator 104 obtains an indication that edge device 100B is ready to perform the tasks, leader election process 206 may be performed. Leader election process 206 may be performed because a container has not been selected to be a leader container. During leader election process 204, edge orchestrator 104 may select a container on edge device 100A, edge device 100B, or any number of edge devices within deployment 100. The container may be part of a pod that has been deployed to edge device 100A, edge device 100B, of the any number of the edge devices.

The container that is selected may become the leader container. The leader container may have a task of balancing a load in deployment 100 by distributing tasks. The tasks may be performed to provide the computer implemented services. The tasks may be performed by a follower container, which is one of any number of containers other than the leader container.

To select the leader container, edge orchestrator 104 may perform interaction 208 and interaction 210. During interaction 208 and interaction 210, edge orchestrator 104 may send a notice to the containers on edge device 100A and edge device 100B that a leader container is needed to distribute resources of the pod in deployment 100. The notice may include requirements to qualify as the leader container. The requirements may include (i) enhanced security protocols, (ii) increased available resources to manage tasks, (iii) continuous scanning for malicious activity, etc.

A portion of the containers that meet the requirements of the leader container may respond to edge orchestrator 104. A container of the portion of the containers may respond by sending a signature of the container to the edge orchestrator. The signature may be used to identify the container.

Edge orchestrator 104 may receive the signature of the container of the portion of the containers. The edge orchestrator may then select the container to be the leader container. The edge orchestrator may select the leader container by (i) using the signature of the container to perform a lookup of attributes of the container of the portion of the containers, and (ii) select the container, which has the attributes that meet the requirements, to be the leader container.

Once the leader container has been selected, leader establishment process 214 may be performed. During leader establishment process 214, the signature of the container may be used to establish the container as the leader container. The signature may be used by writing the signature in memory in edge orchestrator 104. By writing the signature in the memory, edge orchestrator 104 may follow that a container from a pod deployed to, for example, edge device 100A, may now include the leader container. The leader container from edge device 100A may now be responsible with distributing tasks to a container.

Thus, via the interaction illustrated in FIG. 2A, a system in accordance with an embodiment may select the leader container. Consequently, a deployment (e.g., 100) may be more likely to be able to provide desired computer implemented services by delegating distribution of tasks to the leader container.

Turning to FIG. 2B, a second interaction diagram in accordance with an embodiment is shown. The second interaction diagram may illustrate data used in and data processing performed in obtaining and analyzing a policy for a follower container.

To obtain and analyze the policy, leader signature 216 may be obtained by edge orchestrator 104. Leader signature 216 may be obtained from leader establishment process 214 as described in the description of FIG. 2A. Leader signature 216 may be a signature to identify a container from edge device 100A as the leader container for deployment 100.

Once leader signature 216 is obtained by edge orchestrator 104, during interaction 218, leader signature 216 may be transferred to a follower container, including the follower container that is deployed to edge device 100B. Leader signature 216 may be transferred through shared memory, a data stream, message queues, etc. Once the follower container receives leader signature 216, leader monitoring process 220 may be performed.

During leader monitoring process 220, a follower container may monitor activity of the leader container. The follower container may monitor activity of the leader container by focusing on a performance of activities of the leader container. The follower container may monitor the leader container in anticipation of receiving a task from the leader container.

During leader monitoring process 220, the follower container may detect an absence of the leader container if the leader container shuts off and/or edge device 110A powers down. The leader container may shut off and/or edge device 100A may power down due to (i) exceeding resources, (ii) encountering errors in an application, (iii) failing a health check, (iv) requiring a restart from configuration changes, etc. If the leader container shuts off and/or edge device 100A powers down, edge orchestrator 104 may remove leader signature 216 from memory as a leader container and perform another election for the leader container.

While the follower container monitors the leader container, task acquisition process 222 may be performed. During task acquisition process 222, the leader container may obtain a task to be performed. The task may be performed to provide a computer implemented service. The leader container may obtain the task during interaction 224.

During interaction 224, the leader container may obtain the task by requesting the task from task manager 106. Task manager 106 may select task 226 from a set of tasks that are in a buffer to be performed by a follower container. Task 226 may be reported to the leader container in edge device 100A during interaction 228. Task 226 may be reported by sending, by task manager 226, task 226 to the leader container. The leader container may receive task 226. Once the leader container receives task 226, the leader container may assign task 226 to the follower container.

To assign task 226 to the follower container, the leader container may analyze a policy of the follower container. To analyze the policy of the follower container, the leader container may wait for the follower container to transfer the policy. To transfer the policy, device policy retrieval process 230 may be performed.

During policy retrieval process 230, the follower container may obtain the policy from edge device 100B. The follower container may obtain the policy by reading the policy from at least one source including a configuration file, environmental variable, registry, database, etc. Upon reading device policy 234, device policy 234 may be stored in memory, a message queue, etc. Once device policy 234 is obtained from the at least one of the sources, device policy 234 may be transferred to the leader container in edge device 100A.

Device policy 234 may be received by the leader container and policy analysis process 232 may be performed. During policy analysis process 234, the leader container may parse device policy 234. The leader container may parse device policy 234 by converting it into a structured format and validating that device policy 234 is in the structured format. The structured format may be a readable format by the leader container. Then, the leader container may evaluate device policy 234 in the structure format.

During policy analysis process 232, the leader container may determine whether a task can be performed by the follower container. Whether the task can be performed by the follower container may depend at least an allowable allocation of resources by the follower container and/or the type of data that is ingested by the follower container. From this, the leader container may decide at least if performance of the task may exceed the allowable allocation of the resources and/or the follower container is permitted to ingest the type of data used in the task.

Thus, via the interaction illustrated in FIG. 2B, a system in accordance with an embodiment may obtain and analyze a policy for the follower container. Consequently, a deployment (e.g., 100) may be more likely to be able to provide desired computer implemented services by having the leader container determine, by the analysis of the policy, whether performance of a task by the follower container is permitted by the policy.

Turning to FIG. 2C, a third interaction diagram in accordance with an embodiment is shown. The third interaction diagram may illustrate data used in and data processing performed in performing a computer implemented service.

To perform the computer implemented service, device assigned task 236 may be generated from policy analysis process 232. Device assigned task 236 may be a task that falls within the device policy 234 and therefore may be performed by the follower container. The leader container may therefore transfer device assigned task 236 to the follower container for performance of the task.

The follower container may receive device assigned task 236. Upon receiving device assigned task 236, the follower container may perform task queue process 238. During task queue process 238, the follower container may send device assigned task 236 to a buffer in edge device 100B. The follower container may send device assigned task 236 to the buffer by transferring device assigned task 236 to the buffer that will be performed by the follower container. Once set in the buffer, device assigned task 236 may become queued task 240.

Queued task 240 may be included with a priority label, with labels such as normal, high, etc., that determines where in the buffer that device assigned task 236 may be placed. If the priority label may be listed as “normal,” then queued task 240 may be performed after at least one other task, placed in the buffer before queued task 240, is performed. Otherwise, if the priority label may be listed as “high,” then queued task 240 may be performed before at least one other task is performed.

To perform, by the follower container, queued task 240, service process 242 may be performed. To perform service process 242, queued task 240 may be selected from the buffer. Once queued task 240 is selected, the follower container may process queued task 240 to understand what dependencies are needed for sub-processes and/or what data may be ingested by queued task 240. The dependencies may be present on the follower container and/or a second follower container. Further, the data may be acquired by and/or stored in memory and/or file storage on edge device 100B. The data may be ingested by an application on the follower container and/or a dependency of the dependencies. The application may then perform an instruction from queued task 240 to therefore provide the computer implemented service.

Thus, via the interaction illustrated in FIG. 2C, a system in accordance with an embodiment may perform the computer implemented service. Consequently, a deployment (e.g., 100) may be more likely to be able to provide desired computer implemented services by assigning a task to a follower container and following an instruction of the task to provide the computer implemented service. As discussed above, the components of FIG. 1 may perform various methods to managing operation of a deployment. FIGS. 3A-3C illustrate a method that may be performed by the components of the system of FIG. 1. In the diagram discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method of managing operation of a deployment in accordance with an embodiment is shown. The method may be performed, for example, by any of the components of the system of FIG. 1, and/or other components not shown therein.

At operation 300, a task from a task manager may be obtained, by a first container of a pod hosted by the deployment, to provide at least one computer implemented service. The task may be obtained by receiving, by the first container, the task from the task manager.

At operation 302, at least a policy and an available workload capacity for taking on additional tasks by the second container may be obtained, based on the task, by the first container and from a second container of the pod, which are usable to identify whether the task can be performed by the second container. At least the policy and the available workload capacity may be obtained by receiving, by the first container and from the second container, at least the policy and the available workload capacity.

Turning to FIG. 3B, at operation 306, a determination, based on at least the policy and the available workload capacity, may be made regarding whether the task can be performed by the second container. The determination may be made by (i) screening, by the first container, the policy of the second container to ingest parameters of the decision-making procedure that regulates whether the task can be completed by the second container, (ii) determining, by the first container and based on the parameters of the decision-making procedure, whether performance of the task by the second container is prohibited by the policy of the second container, and (iii) determining, by the first container, whether performance of the task can be done within the available workload capacity.

The policy of the second container may be screened by parsing, by the first container, the policy of the second container and converting the policy into a data structure that is readable by the first container. Whether the performance of the task by the second container is prohibited by the policy may be determined by reading, by the first container, the parameters of the decision-making procedure and comparing the parameters to the policy that is readable of by the first container. Whether the performance of the task can be done may be determined by (i) reading, by the first container, an output of the comparison of the parameters and the policy and (ii) validating an instruction from the output from the comparison before following the instruction.

If the task can be performed by the second container, then the method may continue at operation 308. Otherwise, if the task cannot be performed by the second container, then the method may continue at operation 312.

Continuing from operation 306, at operation 308, the task may be assigned, to the second container, to be performed. The task may be assigned by sending, by the first container and to the second container, the task with the instruction to perform the task.

At operation 310, performance of the task, by the second container, may be monitored by the first container, to ensure that the at least one computer implemented service is being performed by the performance of the task. The performance of the task may be monitored by receiving, by the first container and from the second container, status updates, metrics, logs, etc.

The method may end following operation 310.

Continuing from operation 306, at operation 312, at least a second policy and a second available workload capacity for taking on additional tasks by a third container may be obtained, based on the task, by the first container and from a third container of the pod, that are usable to identify whether the task can be performed by the third container. At least the second policy and the second available workload capacity may be obtained by receiving, by the first container and from the third container, at least the second policy and the second available workload capacity.

The method may end following operation 312.

Thus, via the method shown in FIGS. 3A-3B, embodiments herein may likely manage operation of the deployment. By managing operation of the deployment, the data processing systems may be more likely to provide desirable computer implemented services by, for example, screening the policy, by the first container, to see if the performance of the task can be done by the second container, delegating and monitoring, by the first container, the performance of a task by a second container to scale a workload in a deployment, etc.

Turning to FIG. 3C, a third flow diagram illustrating a method of managing operation of a deployment in accordance with an embodiment is shown. The method may be performed, for example, by any of the components of the system of FIG. 1, and/or other components not shown therein.

At operation 314, a first notice, from a remote management entity, may be received that an election is taking place to choose a leader container from a set of containers. The first notice may be received by obtaining, by the containers, the first notice after the first notice was sent from the remote management entity.

At operation 316, a signature may be sent to the remote management entity to be selected as the leader container. The signature may be sent by transferring, by a container of the set of the containers, the signature, which identifies the container, to the remote management entity.

At operation 318, a second notice may be received that the signature was selected by the remote management entity to be designated as the leader container. The second notice may be received by obtaining, by the containers, the second notice after the second notice was sent from the remote management entity. The second notice may notify the containers that the signature has been obtained by the remote management entity and therefore the leader container can be identified by the signature.

At operation 320, a third notice may be received from a follower container that the follower container is ready to receive the task. The third notice may be received by transferring, by the follower container and to the leader container, the third notice.

The method may end following operation 320.

Thus, via the method shown in FIG. 3C, embodiments herein may likely manage operation of the deployment. By managing operation of the deployment, the data processing systems may be more likely to provide desirable computer implemented services by, for example, selecting a leader container delegate a task, preparing a follower container to receive the task from the leader container, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
obtaining, by a first container of a pod hosted by the deployment, a task from a task manager to provide at least one computer implemented service;
based on the task:
obtaining, by the first container and from a second container of the pod, at least a policy and an available workload capacity for taking on additional tasks by the second container that are usable to identify whether the task can be performed by the second container;
making, based on at least the policy and the available workload capacity, a determination regarding whether the task can be performed by the second container;
in a first instance of the determination where the task can be performed by the second container:
assigning, to the second container, the task to be performed; and
monitoring, by the first container, performance of the task by the second container to ensure that the at least one computer implemented service is being provided by the performance of the task.

2. The method of claim 1, further comprising:
before obtaining the task from the task manager:
receiving, from a remote management entity, a first notice that an election is taking place to choose a leader container from a set of containers;
sending, to the remote management entity, a signature to be selected as the leader container;
receiving a second notice that the signature was selected by the remote management entity to be designated as the leader container; and
receiving, from a follower container, a third notice that the follower container is ready to receive the task.

3. The method of claim 2, wherein the signature is used to identify the pod among the set of the containers.

4. The method of claim 1, further comprising:
after obtaining the task from the task manager:
receiving, from a remote management entity, a third notice that a signature for a container has been removed, thereby removing a container from a leadership position;
receiving, from the remote management entity, a fourth notice that a second election is taking place to choose a leader container from a set of containers;
receiving a fifth notice that the signature was selected by the remote management entity to be designated as a new leader container; and
sending, to the new leader container, a sixth notice that the task is ready to be received.

5. The method of claim 1, wherein the task manager aggregates tasks in a list of the tasks and does not balance the available workload capacity for containers.

6. The method of claim 5, wherein the first container acquires the task from the list of the tasks aggregated by the task manager to send to the second container.

7. The method of claim 1, wherein the first container is a leader that delegates the task to the second container, the second container being a follower that accomplishes the task, and the leader is selected in an election, by an elector, between the first container and the second container that chooses which container can more efficiently delegate the task, monitor performance of the task, and is more secure.

8. The method of claim 1, wherein the policy comprises a decision-making procedure that regulates, based on at least a first type of operation, an allowable allocation of resources, and a second type of data that is ingested in the operation, whether a task can be completed by a container.

9. The method of claim 8, wherein making the determination regarding whether the task can be performed comprises:
screening, by the first container, the policy of the second container to ingest parameters of the decision-making procedure that regulates whether the task can be completed by the second container;
determining, by the first container and based on the parameters of the decision-making procedure, whether performance of the task by the second container is prohibited by the policy of the second container; and
determining, by the first container, whether performance of the task can be done within the available workload capacity.

10. The method of claim 1, wherein performance of the task by the second container depends on whether the performance can be completed within a timeframe based on a service limit understood by the first container.

11. The method of claim 1, wherein the determination is made based on computational efficiency criteria that comprises at least a high proximity to data sources.

12. A non-transitory machine-readable medium having instructions stored therein, which when executed by a processor, cause the processor to perform operations for managing operation of a deployment, the operations comprising:
obtaining, by a first container of a pod hosted by the deployment, a task from a task manager to provide at least one computer implemented service;
based on the task:
obtaining, by the first container and from a second container of the pod, at least a policy and an available workload capacity for taking on additional tasks by the second container that are usable to identify whether the task can be performed by the second container;
making, based on at least the policy and the available workload capacity, a determination regarding whether the task can be performed by the second container;
in a first instance of the determination where the task can be performed by the second container:
assigning, to the second container, the task to be performed; and
monitoring, by the first container, performance of the task by the second container to ensure that the at least one computer implemented service is being provided by the performance of the task.

13. The non-transitory machine-readable medium of claim 12, wherein the operations further comprise:
before obtaining the task from the task manager:
receiving, from a remote management entity, a first notice that an election is taking place to choose a leader container from a set of containers;
sending, to the remote management entity, a signature to be selected as the leader container;
receiving a second notice that the signature was selected by the remote management entity to be designated as the leader container; and
receiving, from a follower container, a third notice that the follower
container is ready to receive the task.

14. The non-transitory machine-readable medium of claim 13, wherein the signature is used to identify the pod among the set of the containers.

15. The non-transitory machine-readable medium of claim 12, wherein the operations further comprise:
after obtaining the task from the task manager:
receiving, from a remote management entity, a third notice that a signature for a container has been removed, thereby removing the container from a leadership position;
receiving, from the remote management entity, a fourth notice that a second election is taking place to choose a leader container from a set of containers;
receiving a fifth notice that the signature was selected by the remote management entity to be designated as a new leader container; and
sending, to the new leader container, a sixth notice that the task is ready to be received.

16. The non-transitory machine-readable medium of claim 12, wherein the task manager aggregates tasks in a list of the tasks and does not balance the available workload capacity for containers.

17. A data processing system, comprising:
a processor; and
a memory coupled to the processor to store instructions, which when executed by the processor, cause the processor to perform operations managing operation of a deployment, the operations comprising:
obtaining, by a first container of a pod hosted by the deployment, a task from a task manager to provide at least one computer implemented service;
based on the task:
obtaining, by the first container and from a second container of the pod, at least a policy and an available workload capacity for taking on additional tasks by the second container that are usable to identify whether the task can be performed by the second container;
making, based on at least the policy and the available workload capacity, a determination regarding whether the task can be performed by the second container;
in a first instance of the determination where the task can be performed by the second container:
assigning, to the second container, the task to be performed; and
monitoring, by the first container, performance of the task by the second container to ensure that the at least one computer implemented service is being provided by the performance of the task.

18. The data processing system of claim 17, wherein the operations further comprise:
before obtaining the task from the task manager:
receiving, from a remote management entity, a first notice that an election is taking place to choose a leader container from a set of containers;
sending, to the remote management entity, a signature to be selected as the leader container;
receiving a second notice that the signature was selected by the remote management entity to be designated as the leader container; and
receiving, from a follower container, a third notice that the follower container is ready to receive the task.

19. The data processing system of claim 18, wherein the signature is used to identify the pod among the set of the containers.

20. The data processing system of claim 17, wherein the operations further comprise:
after obtaining the task from the task manager:
receiving, from a remote management entity, a third notice that a signature for a container has been removed, thereby removing the container from a leadership position;
receiving, from the remote management entity, a fourth notice that a second election is taking place to choose a leader container from a set of containers;
receiving a fifth notice that the signature was selected by the remote management entity to be designated as a new leader container; and
sending, to the new leader container, a sixth notice that the task is ready to be received.
